(19) United States
(12) Patent Application Publication
(10) Pub. No.: US 2009/0083559 A1
(43) Pub. Date: Mar. 26, 2009

(54) ELECTRONIC DEVICE AND METHOD OF CONTROLLING POWER THEREOF

(75) Inventor: Akihiro Matsumoto, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/200,751

(22) Filed: Aug. 28, 2008

(30) Foreign Application Priority Data
Sep. 21, 2007 (JP) 2007-246094

(51) Int. Cl. G06F 1/32; G06F 1/04

(52) U.S. Cl. 713/320; 713/601

(57) ABSTRACT

In an electronic device having a plurality of processing elements PEs that operate in synch with a clock signal, each of the plurality of PEs generates its own operating clock signal in accordance with a clock enable signal that is input together with data from an outside or from a PE of a preceding stage, processes the input data in response to this operating clock signal, outputs this processed data to a PE of a succeeding stage and outputs the clock enable signal to the PE of the succeeding stage, and halts generation of its own operating clock signal when output of the processed data is completed following completion of processing of the data.

### BACKGROUND OF THE INVENTION

1. Field of the Invention

The present invention relates to an electronic device and to a power control method for reducing electric power consumption in the device.

2. Description of the Related Art

Since high performance and high added value are sought for digital devices such as printers, there is a tendency for increased power consumption in such devices. Conversely, energy conservation specifications such as those of the international Energy Star Program (the TEC standard) have resulted in stricter standards year after year. Accordingly, the demand from both consumers and manufacturers for reductions in power consumption is great.

According to the TEC standard mentioned above, power consumption inclusive not only of operating power but also of standby power must be suppressed. Taking a printer as an example, a method of supplying power only to the minimum necessary circuits and cutting off supply of power to circuits other than these when the printer is not operating (i.e., when the printer is in a waiting state in which there is no request for execution of a job) is common (and is referred to as putting the device to “sleep”).

Ideally, even at the time of standby or when a printer is waiting, the supply of a major portion of the power is cut off and power is supplied only to the necessary components when a print request is received. When such control is carried out, however, processing speed declines because processing for restoring power takes time. Further, depending upon the connected devices (a hard-disk drive, etc.), there is a limit on the number of times the power supply can be turned on and off. This makes such control of the power supply difficult. In addition, it is difficult to turn the supply of power to circuits, etc., on and off in partial fashion (for example, to isolate the power supply within a chip and turn the supply of power on and off in partial fashion). For these and other reasons, the above-described control of supply of power has not been achieved.

This has led to proposals of other methods, such as a method of supplying power at all times and reducing power consumption by controlling the clock signal. For example, there is a gated-clock method that temporarily shuts down clock oscillation with the exception of clock signals that are necessary. There is also a method of controlling a gated-clock register by software as a method of controlling a gated clock.

In case of control by software, however, the unit of system power-supply control must be more finely divided in order to raise the efficiency with which power consumption is reduced. However, the more the unit of control is subdivided, the more complicated processing becomes and the greater the load to which the CPU is subjected. Furthermore, since the time interval over which control is feasible lengthens in the case of control by software, fine dynamic control is not possible. This imposes a limitation upon reductions in power consumption.

A method of controlling a clock using hardware has been proposed as a solution. Several examples will be cited below. Japanese Patent Application Laid-Open No. 8-272479 (page 7, FIG. 1) discloses a method in which a plurality of clock signals such as a high-speed clock and a low-speed clock are prepared and the oscillation frequency of the clock signal is varied in accordance with the content of a processing unit.

Further, according to Japanese Patent Application Laid-Open No. 2002-108489 (page 6, FIG. 1) which discloses another method of controlling a clock signal by hardware, there is a main module that supplies the clock signal and a plurality of submodules to which this clock signal is supplied. The main module starts supplying the submodule that requests processing with the clock at the same time as the transaction. The submodule that has accepted the transaction continues to assert a clock-delay request signal that delays the supply of the clock signal for a period of time necessary for processing.

However, Japanese Patent Application Laid-Open No. 8-272479 presumes a system in which variation of the clock signal is permitted and therefore is disadvantageous in that the scope of application is limited. Further, the circuit configuration is comparatively complicated since a priority-condition determination circuit and frequency dividing circuit, etc., are required. Further, the basic structure of Japanese Patent Application Laid-Open No. 2002-108489 is a master-and-slave structure in terms of clock control, and a handshake is generated between the master and slave. Accordingly, the circuit configuration is also complicated. A further disadvantage of the master-slave configuration is that application is difficult, depending upon the system configuration.

### SUMMARY OF THE INVENTION

An aspect of the present invention is to eliminate the above-mentioned problems encountered with the conventional technology.

According to an aspect of the present invention, there is provided an electronic device having a plurality of processing elements PEs that operate in synch with a clock signal, each of the plurality of PEs comprising: a clock generator configured to generate an operating clock signal of the PE in accordance with a clock enable signal that is input together with data from an outside or from a PE of a preceding stage; a processing unit configured to process input data in a case where the clock generator generates the operating clock signal; an output unit configured to output a clock enable signal to a PE of a succeeding stage and output processed data, which has been processed by the processing unit, to the PE of the succeeding stage; and a halt unit configured to halt generation of the operating clock signal by the clock generator in response to completion of processing of the input data by the processing unit and completion of output of the processed data by the output unit.

According to another aspect of the present invention, there is provided a method of controlling power of an electronic device having a plurality of processing elements PEs that operate in synch with a clock signal, the method comprising: a clock generating step of generating at each of the plurality of PEs an operating clock signal of the PE in accordance with a clock enable signal that is input together with data from the outside or from a PE of a preceding stage; a processing step of processing input data at each of the plurality of PEs in a case where the operating clock signal is generated in the clock generating step; an output step of outputting a clock enable signal to a PE of a succeeding stage and outputting processed data, which has been processed in the processing step, to the PE of the succeeding stage; and a halting step of halting generation of the operating clock signal in the clock generating step in response to completion of processing of the input data in the processing step and completion of output of the processed data in the output step.

Further features of the present invention will become apparent from the following description of an exemplary embodiment with reference to the attached drawings.

### BRIEF DESCRIPTION OF THE DRAWINGS

The accompanying drawings, which are incorporated in and constitute a part of the specification, illustrate an exemplary embodiment of the invention and, together with the description, serve to explain the principles of the invention.

FIG. 1 is a timing chart illustrating an example of the states of clock signals and data buses of respective processing blocks (processing elements) shown in FIG. 5 according to an exemplary embodiment of the present invention;

FIG. 2 is a block diagram illustrating an example of the configuration of a controller of a multifunction peripheral (MFP) according to this embodiment;

FIG. 3 is a diagram illustrating a portion of the controller of this embodiment is greater detail;

FIG. 4 is a diagram useful in describing the flow of data in a main chip when fax data is received;

FIG. 5 is a diagram illustrating the relationship among processing elements, which are the basic structural components of this embodiment;

FIG. 6 is a diagram illustrating state transition of a clock control circuit included in each of processing elements PE-A to PE-B of FIG. 5;

FIG. 7 is a timing chart illustrating another example of the states of clock signals and data buses of respective processing blocks (processing elements) shown in FIG. 5 according to this embodiment;

FIG. 8 is a diagram illustrating an example of the circuit configuration of a gated-clock unit according to this embodiment;

FIG. 9 is a diagram illustrating a modification among processing blocks illustrated in FIG. 5 of this embodiment;

FIG. 10 is a diagram illustrating another modification among processing blocks illustrated in FIG. 5 of this embodiment;

FIG. 11 is a diagram illustrating an arrangement composed basically of processing blocks similar to those of FIG. 9, in which data that has been input from PE-A 501 to PE-B 502 is returned to PE-A 501 after being processed by PE-B 502;

FIG. 12 is a diagram illustrating a PE array similar to that of FIG. 10 and showing an example in which the format of data that flows in a data bus is the format of packet data;

FIG. 13 is a diagram illustrating an example of a configuration in which two sub-chips are connected to a main chip in this embodiment;

FIG. 14 is a diagram useful in describing another example in which a clock-enable signal between chips is connected according to this embodiment; and

FIG. 15 is a diagram illustrating a configuration the same as that in FIG. 13 and showing states at the time of standby.

### DESCRIPTION OF THE EMBODIMENTS

A preferred embodiment of the present invention will now be described hereinafter in detail, with reference to the accompanying drawings. It is to be understood that the following embodiment is not intended to limit the claims of the present invention, and that not all of the combinations of the aspects that are described according to the following embodiment are necessarily required with respect to the means for solving the problems according to the present invention.

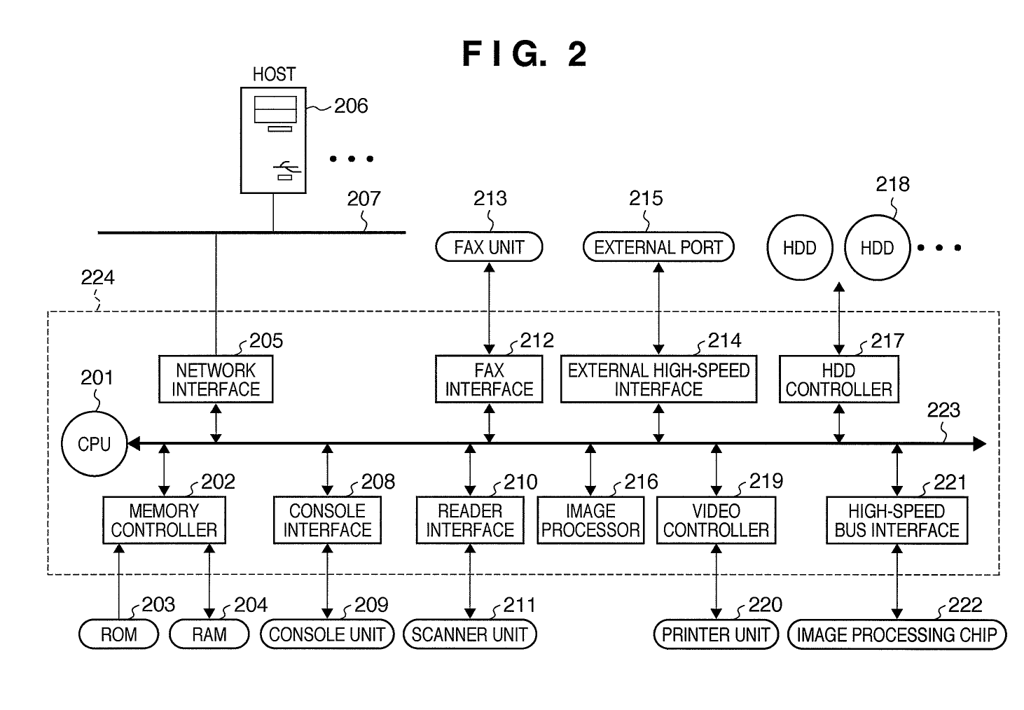

FIG. 2 is a block diagram illustrating an example of the configuration of a controller 224 of a multifunction peripheral (MFP) according to this embodiment of the present invention. The multifunction peripheral includes a fax function, a copy function, a printer function and a storage function, etc. Although an MFP is described in this embodiment as an example of an electronic device according to the present invention, the invention is not limited to such a device and can be applied to all devices and apparatus that operate upon being supplied with electric power from a commercial source or battery, etc., such as electrical appliances for home use, information processors such as personal computers, communications devices and printers.

A CPU 201 controls operation of this MFP, sets various registers and executes processing, etc., in accordance with a program that has been loaded in a ROM 203 or RAM 204. A memory controller 202 controls input and output to and from the ROM 203 and RAM 204 and executes DMA (Direct Memory Access) control as well. The ROM 203 is a non-volatile memory that stores data such as programs and fonts that will not be changed. The RAM 204 is a volatile memory typified by a SDRAM or DDR and is used in applications that require rewriting of a program working area or print-data storage area, etc.

A network interface 205 controls interfacing with a network 207 and generally supports the TCP/IP protocol. The MFP is connected via the network 207 to a network-supported device such as a host device 206 and functions also as a network printer for receiving and printing print data from the host device 206. A console interface 208 controls communication with a console unit 209. The console unit 209 has a liquid crystal display unit and various operating buttons and functions as a user interface operated by a user to make various settings.

A reader interface 210 controls communication with a scanner unit 211, inputs image data of a document scanned in by the scanner unit 211 and implements a copy function. A fax interface 212 controls communication with a fax unit 213 via a communication line and executes fax-data transceive processing for sending and receiving fax data to and from the fax unit 213, which has been connected to, for example, a telephone line. An external high-speed interface 214 is connected to an external port 215 by a high-speed interface such as PCI-Express and executes print-data transceive processing. An image processor 216 applies image processing such as dither processing or edge processing to image data that has been loaded via the network interface 205, reader interface 210, fax interface 212 or external high-speed interface 214. Processing executed by the image processor 216 includes processing for compressing and expanding image data.

An HDD controller 217 controls input and output of data to and from a hard-disk drive (HDD) 218 according to the ATA standard (Parallel-ATA or Serial ATA, etc.). The hard-disk drive 218 is a non-volatile large-capacity storage device and is used for file storage and as a primary storage location for print data. A video controller 219 controls communication of commands/status with a printer unit 220 and sends the printer unit 220 print data generated in the RAM 204. The printer unit 220 primarily prints an image on paper by executing printing that is based upon print data in accordance with command information from the video controller 219. A high-speed bus interface 221 connects an image processing chip 222 and controls data input/output. By way of example, if a controller 224 enclosed by the dashed line in FIG. 2 is assumed to be a main chip that includes a CPU core, then the chip 222, which executes processing that assists the internal image processor 216 and other processing as well, is connected to the high-speed bus interface 221. As a result, processing by the image processing chip 222 becomes possible. A system bus 223 is expressed, for the sake of convenience, as a bus obtained by combining a control bus, a data bus, a local bus between any blocks (PEs) and a signal line into a whole.

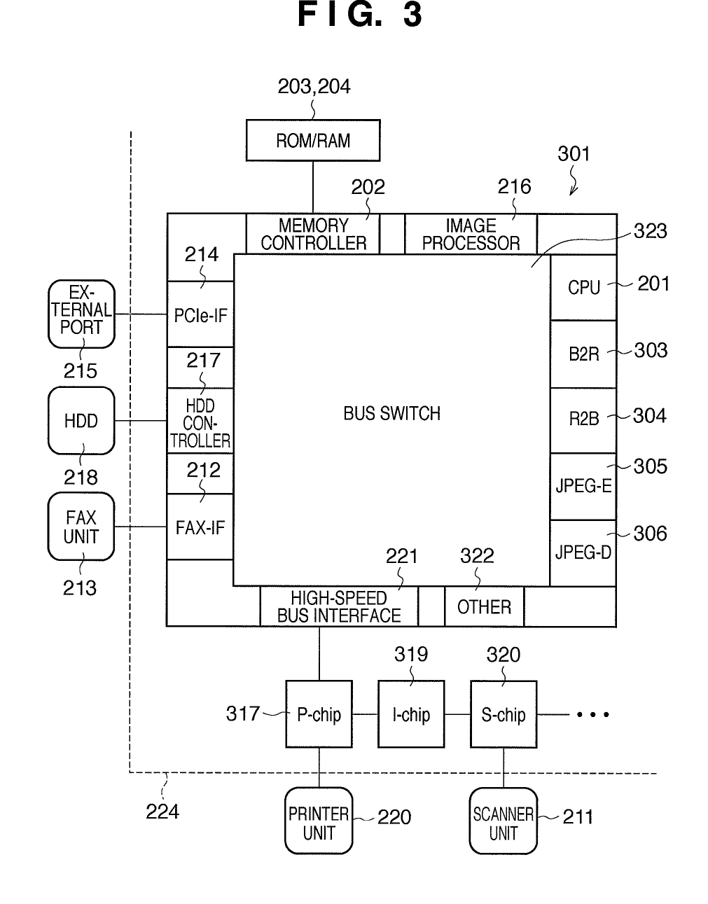

FIG. 3 is a diagram illustrating a portion of the controller 224 of this embodiment in greater detail. The inner side of the dashed line in FIG. 3 indicates the controller (board) 224. Components in FIG. 3 similar to those shown in FIG. 2 are designated by like reference characters.

A main chip 301 is a main control chip. This is an SoC (System on a Chip) composed of a plurality of IP modules. The internal structure indicated by the main chip 301 is indicative of one example of an SoC. The internal structure of the main chip 301 will be described below in simple terms.

A B2R 303 converts data, which has been placed in block form, to raster data. Conversely, an R2B 304 converts raster data to block data. The B2R 303 and R2B 304 are used in packet processing for passing data in block units. A JPEG-E 305 compresses still-image data that is in the JPEG (Joint Photographic Experts Group) format, and a JPEG-D 306 expands image data that has been undergone JPEG compression. The memory controller 202 controls an exchange of data with memories such as the ROM 203 and RAM 204. The image processor 216 subjects an image to various image processing such as dither processing, screen processing and smoothing processing. The external high-speed interface 214, which is a PCIe interface, for example, performs high-speed serial-bus control according to the PCI-Express standard and is connected to the hard-disk drive 218 via a special-purpose cable. The fax interface 212 is connected to the fax unit 213 via a communication line and controls communication with the fax unit 213. The high-speed bus interface 221 is connected by a bus to another chip on the board, controls data input/output and is connected to a subchip group consisting of a P-chip 317, I-chip 319 and S-chip 320, etc.

The P-chip 317 applies further image processing (manipulation and shaping) to print data supplied from the main chip 301, creates the final print data and transmits this print data to the printer unit 220, where the image represented by this print data is printed. The I-chip 319 executes various processing for assisting and extending the image processor 216 of main chip 301. The S-chip 320 applies image processing (manipulation and shaping) to image data that has been read in by the scanner 211. An “other” block 322 indicates other function blocks that are not illustrated. A bus switch 323 has a selector function for connecting the above-mentioned components together by a bus. An appropriate connection among the components that are to execute the desired processing is selected by the bus switch 323.

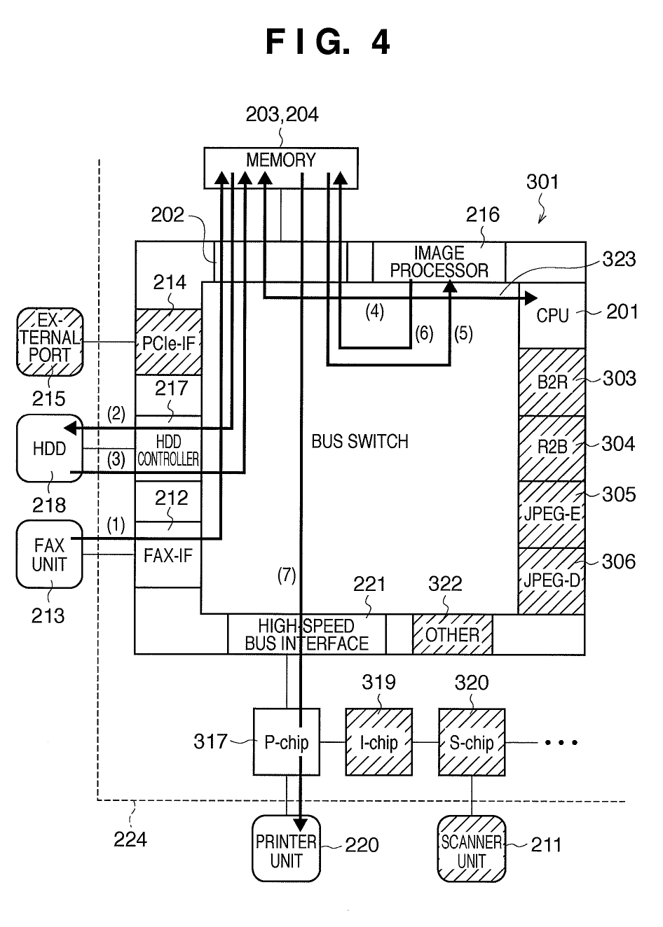

FIG. 4 is a diagram useful in describing the flow of data in the main chip 301 when fax data is received. Data is accepted and delivered in the order indicated by the numerals in parentheses appended to the arrows. Data flow up to the printing of receive data from the fax unit will be described below. Components similar to those shown in FIG. 3 are designated by like reference characters.

Fax data received by the fax unit 213 is buffered sequentially in the RAM 204 [arrow (1)]. At the same time, data that has been buffered in the RAM 204 is transferred to the hard-disk drive 218, where the data is spooled [arrow (2)]. Processing continues until all of the fax data thus received is spooled on the hard-disk drive 218. When spooling on the hard-disk drive 218 is thus completed, fax data is again read from the hard-disk drive 218 to the RAM 204 in page units [arrow (3)] and the creation of print data begins. Fax data that has been read out to the RAM 204 is subjected to prescribed manipulation by the CPU 201 [arrow (4)]. The data thus manipulated is transferred to the image processor 216 [arrow (5)]. The image processor 216 applies prescribed image processing to the accepted data and writes the processed data back to the RAM 204 [arrow (6)]. The data that has been written back is transferred in page units to the P-chip 317, which is an external image processing chip. After the data is subjected to image processing here, it is sent to the printer unit 220 and printed [arrow (7)]. The processing indicated by arrows (3) to (7) is repeated until the completion of processing of a page of image data that has been spooled on the hard-disk drive 218.

Here the components indicated by numerals 211, 214, 215, 303 to 306, 319, 320 and 322 in FIG. 4 execute no processing whatsoever. Further, it will be understood that in the above-described processing of fax receive data, processing over the time interval of the arrows (1) to (2) is separate from processing over the time interval of the arrows (3) to (6) in terms of time. That is, while the fax receive data is being spooled on the hard-disk drive 218 in the time interval of the arrows (1) to (2), processing by circuits that operate in the time interval of the arrows (3) to (7) is not necessary simultaneously.

Furthermore, although the image processor 216 includes various image processing functions, it is not necessary to actuate PEs (processing elements) (e.g., for dither processing, screen processing, smoothing processing, etc.) other than the PE for fax data.

Specifically, although the details will be described later, even in the time interval of the arrows (5) to (6) in which image processing is applied to the fax data, time intervals in which waiting time for acceptance and delivery of data occur are contained in large quantity, when viewed on a micro-scale, in time periods during which each type of processing is executed by the image processor 216. One reason for this that can be mentioned is that it is difficult to optimize all and make a transition to pipeline processing.

Accordingly, this embodiment halts the supply of a clock to all circuits not related to the present processing and, furthermore, to components which need not operate in terms of time, even if they are circuits in which processing is in progress, and provides a clock control method that is capable of being adapted to any range over which it is desired to cut off the supply of the clock. As a result, power consumption can be reduced not only at the time of standby but also at the time of printing. Further, a characterizing feature is that control can be exercised comparatively easily in an optimum adaptive range that conforms to each system.

This embodiment will now be described in detail with reference to the drawings.

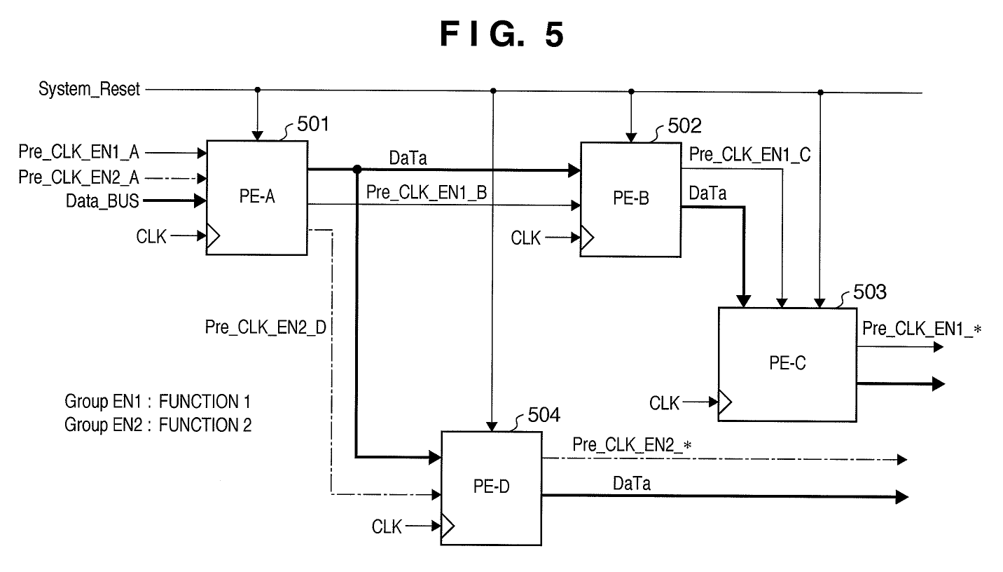

FIG. 5 is a diagram illustrating the relationship among PEs (processing elements), which are the basic structural components of this embodiment. The internal structure of the image processor 216 of FIG. 4 is imagined in this example. PE-A 501 to PE-D 504 have been placed in block form in units of the optimum processing. It may be assumed that each PE performs complicated processing the scale of which is on the order of 500,000 to 1,000,000 gates, or comparatively simple processing the scale of which is on the order of several hundred to several thousand gates.

A reset signal (System_Reset) and a clock signal (CLK) are input in common to each PE. A signal Pre_CLK_EN*_* connected to each PE is an enable signal (ON: oscillation enabled) that controls the ON/OFF status of the clock within the PE. Further, EN1 and EN2 obtained by placing numerals in the “*” portion of EN* represent groups classified by function.

PE-A 501, PE-B 502 and PE-C 503 connected by the enable signal indicated by the solid line cooperate to execute processing of a function 1. A preceding PE connected to the PE-A 501 and a succeeding PE connected to the PE-C 503 are not shown. Although not illustrated, it may be assumed that PEs necessary for implementing the function 1 have been connected at the front and back. In FIG. 5, the clock-enable signal [Pre_CLK_EN1_A(B,C)] that is input to each PE is a signal having a prescribed duration and gives the instruction for the start of processing of function 1 in the PE. It should be noted that duration of the clock-enable signal may be fixed in common for each of the PEs or may be made different for each in accordance with the processing executed by the PE.

Similarly, PE-A 501 and PE-D 504 connected by the enable signal indicated by the dashed-dotted line cooperate to execute processing of a function 2. In this circuit, the PE-A 501 is a PE common to both function 1 and function 2. Further, the clock-enable signal [Pre_CLK_EN2_A(D)] instructs the start of processing of function 2 in the PE.

The signal line connecting the PEs as represented by the bold-line arrows indicates a data bus (Data_BUS). In this embodiment, the flow of the clock-enable signals and data is what is essential and therefore other control signals are omitted. Further, a control signal for measuring timing for accepting and delivering data naturally is connected between PEs, although this is not illustrated. The flow of data shown in FIG. 5 is indicated by an example in which data flows simply from left to right accompanied by the clock-enable signals connected to each of the PEs.

The timing at which the clock-enable signals are generated will be described next.

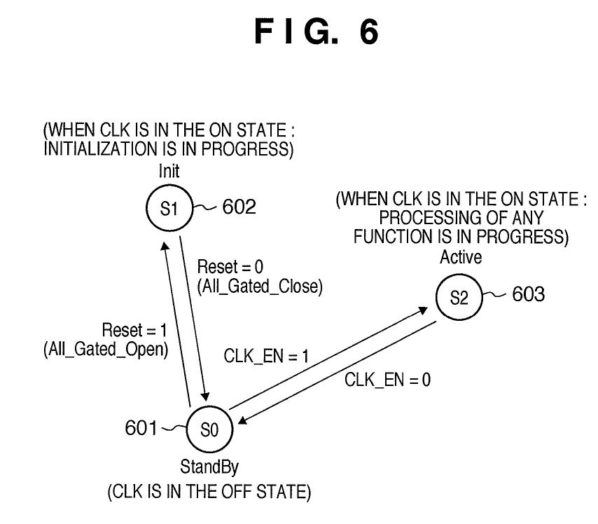

FIG. 6 is a diagram illustrating state transition of a clock control circuit included in each of the processing elements PE-A to PE-B of FIG. 5. Three states make up the basic states.

A state S0 (601) indicates the standby state (a state in which the amount of power consumption has decreased). Here the clock is in the OFF state.

A state S1 (502) indicates an initialization (Init) state. This state is in effect when a reset signal has been enabled. The reset signal includes a system-reset signal and a local-reset signal that internally initializes each PE. (In the example of FIG. 5, the reset signal is a System-Reset signal.)

A state S2 (603) indicates execution in progress (Active). This state is in effect when processing is being executed (is active) owing to supply of the clock signal to the applicable PE.

The condition for the transition between state S0 and state S1 is stipulated by the reset signal. If the reset signal applied to a PE is enabled, then internal signal reset=1 holds and a transition from state S0 to state S1 takes place. In state S1, all clocked gates within the PE open and internal initialization processing is executed. Here it is assumed that even during the reset interval, an operating clock is supplied in a period of time sufficient for internal initialization. If the reset signal is disabled, then internal signal reset=0 holds and a transition from state S1 to state S0 takes place. In state S0, all clocked gates close and a shutdown state (standby state) in which the operating clock signal is not supplied is attained. The amount of power consumed decreases in the shutdown (standby (S0)) state.

The condition for the transition between state S0 and state S2 is stipulated by the CLK_EN signal. If the reset signal applied to a PE is enabled, then internal signal CLK_EN=1 holds and a transition from state S0 to state S2 takes place. In state S2, clocked gates of portions corresponding to the enabled clock-enable signal open, the operating clock signal is supplied and prescribed processing is executed. Here the meaning of “corresponding to the clock-enable signal” will be explained.

As described earlier in FIG. 5, the PE-A 501 is a PE that is common to both functions 1 and 2. Of course, this does not mean that all of the circuitry of PE-A 501 is utilized for both functions 1 and 2. When a circuit corresponding to Pre_CLK_EN1 that is input to the PE-A 501 is made to operate, no harm is done even if operation of circuitry of a portion that corresponds to Pre_CLK_EN2 and that is unnecessary for function 1 is shut down. That is, what the above means is that just as division into the units of processing of PE-A 501 to PE-D 504 has been performed in FIG. 5, the interior of the PE-A 501 also may be further divided into optimized processing units in accordance with the nature of processing of functions 1 and 2. It should be noted, however, that the clock control circuit (state machine) shown in FIG. 6 is required for each PE that has been divided into processing units.

In state S2, all processing units quit and internal clock CLK_EN=0 holds at the moment transmission of data to the PE of the next stage is completed. As a result, a transition from state S2 to state S0 takes place and the standby state (the state in which the clock is OFF) is attained again.

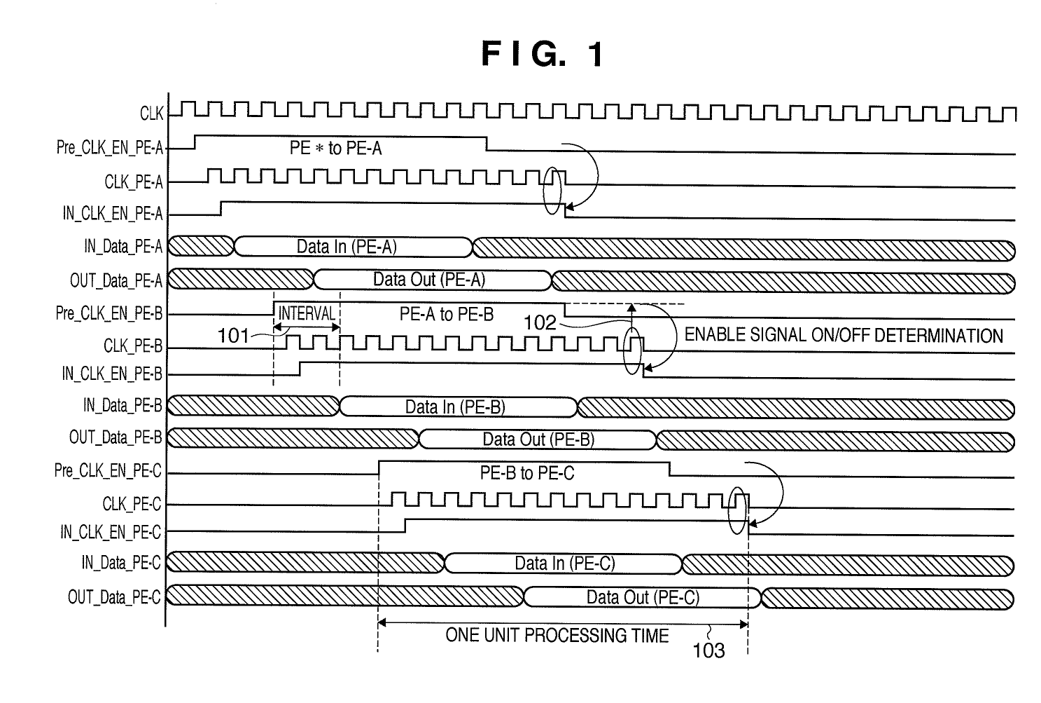

FIG. 1 is a timing chart illustrating an example of the states of clock signals and data buses of respective PEs shown in FIG. 5 according to this embodiment. For the sake of description, some of the signal names have been changed from those shown in FIG. 5. Each of the signals will now be described.

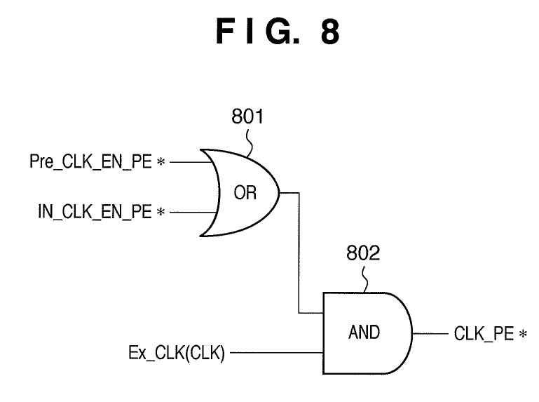

A CLK signal is a clock signal supplied constantly from the outside. A Pre_CLK_EN_PE-* signal is a clock-enable signal supplied from the immediately preceding PE to this PE (PE-*). During the time that this clock-enable signal is at the high level, an operating clock signal CLK_PE-* internal to the PE is generated. Here PE-* corresponds to PE-A 501, PE-B 502, PE-C 503 and PE-D 504 of FIG. 5. The CLK_PE-* signal indicates the operating clock signal actually used in the operation of this PE (PE-*). An IN_CLK_EN_PE-* signal is a clock-enable signal of the PE (PE-*). During the time that this signal or the Pre_CLK_EN_PE-* signal is at the high level, the CLK signal is input to this PE and serves as the operating clock signal (FIG. 8). An IN_Data_PE-* signal is data that is input from the immediately preceding PE to the PE represented by PE-*. An OUT_Data_PE-* signal is data that is output from the PE represented by PE-* to the PE of the succeeding stage. Time periods in which the input data IN_Data_PE-* and output data OUT_Data_PE-* are valid are indicated by white areas in FIG. 1. It should be noted that time periods of input data and output data (processed data) other than the white areas are indeterminate.

Next, the timing at which the operating clock signal is generated and the timing at which data is accepted and delivered will be described taking the PE-B 502 as an example.

The PE-A 501 enables the clock enable signal Pre_CLK_EN_PE-B (i.e., establishes Pre_CLK_EN_PE-B=1) to the PE-B 502 immediately before preparations for output of the output data OUT_Data_PE-A are made. Here the clock-enable signal Pre_CLK_EN_PE-B rises in synch with the falling edge of the CLK signal, and all other internal processing also is synchronized to the rising edge. Of course, it is not necessarily required to use the falling edge, and the design may be such that all internal processing is synchronized to the rising (or falling) edge.

The generation of the operating clock signal CLK_PE-B within the PE-B 502 is started by this clock-enable signal. After handshake of the control signal for acceptance and delivery of data between the PE-A 501 and the PE-B 502, processing by the PE-B 502 starts at the same time that the PE-B 502 accepts the input data IN_Data_PE-B.

Further, after the clock-enable signal Pre_CLK_EN_PE-B rises in the PE-B 502, the clock-enable signal IN_CLK_EN_PE-B within the PE-B 502 is raised to the high level following a prescribed time delay.

The time at which the operating clock signal (CLK_PE-B) of PE-B 502 is output will be described next.

The operating clock signal CLK_PE-B of the PE-B 502 starts being output when the Pre_CLK_EN_PE-B signal attains the high level and stops being output when the IN_CLK_EN_PE-B falls to the low level. That is, this indicates that during the time period that the condition IN_CLK_EN_PE-B=1 holds, processing by the PE-B 502 is being executed. By virtue of this processing, the processed data OUT_Data_PE-B processed and generated by the PE-B 502 is transferred to the PE-C 503 of the succeeding stage. The internal clock signal CLK_PE-B of the PE-B 502, for which transfer of this processed data OUT_Data_PE-B has been completed, continues being generated during the interval of at least one processing unit. This shall be referred to as one unit processing time (103 in FIG. 1). It should be noted that although one unit processing time by PE-C 503 is indicated at 103 in FIG. 1, it is assumed that the same one unit processing time holds for PE-A 501 and PE-B 502.

Whether the clock-enable signal Pre_CLK_EN_PE-B from the PE-A 501 exists or not is thus determined (102) at the rising edge of the operating clock signal CLK_PE-B that prevails immediately after the end of one unit processing time of PE-B 502. If this clock-enable signal is at the high level, generation of the operating clock signal CLK_PE-B is prolonged for the next unit processing time. If this clock-enable signal is at the low level, on the other hand, then generation of the operating clock signal CLK_PE-B is ended in this one unit processing time (at the falling edge of the next clock signal at 102 in the example of FIG. 1) and the operating clock signal of the PE-B 502 attains the shutdown state (standby state).

Thereafter, and in similar fashion, clock-enable signals and data are delivered successively from PE-B 502 to PE-C 503 and then from PE-C 503 to the next PE. That is, by appending a clock signal to data that is output from a certain PE and then transferring the data, the generation of an operating clock signal at a certain PE is propagated to the next PE. In a time interval in which valid data does not exist, therefore, the operating clock signal of each PE stops being generated automatically. It is thus possible to suppress power consumption at each PE.

Two characterizing features of the above-described embodiment are as set forth below.

(1) The first is that this embodiment can be implemented by a simple clock control circuit, as described with reference to FIG. 6. Since the design of modern ASICs in the mainstream uses HDL (Hardware Description Language), a clock control circuit (state machine) can be created in simple fashion by copying and pasting to the PE to which adaptation is desired.

It should be noted that in the time interval over which data is accepted and delivered from the PE-A 501 to the PE-B 502 in FIG. 1, it is necessary to assure a time interval 101 such that the PE-B 502 will accept the data reliably, particularly after the clock-enable signal Pre_CLK_EN_PE-B is raised to the high level. In a case where high speed is required, it is necessary that the time interval 101 be optimized between PEs. Further, with respect to PEs having leeway with regard to processing speed, the time interval 101 may be fixed uniformly as a period of time adequate for accepting data.

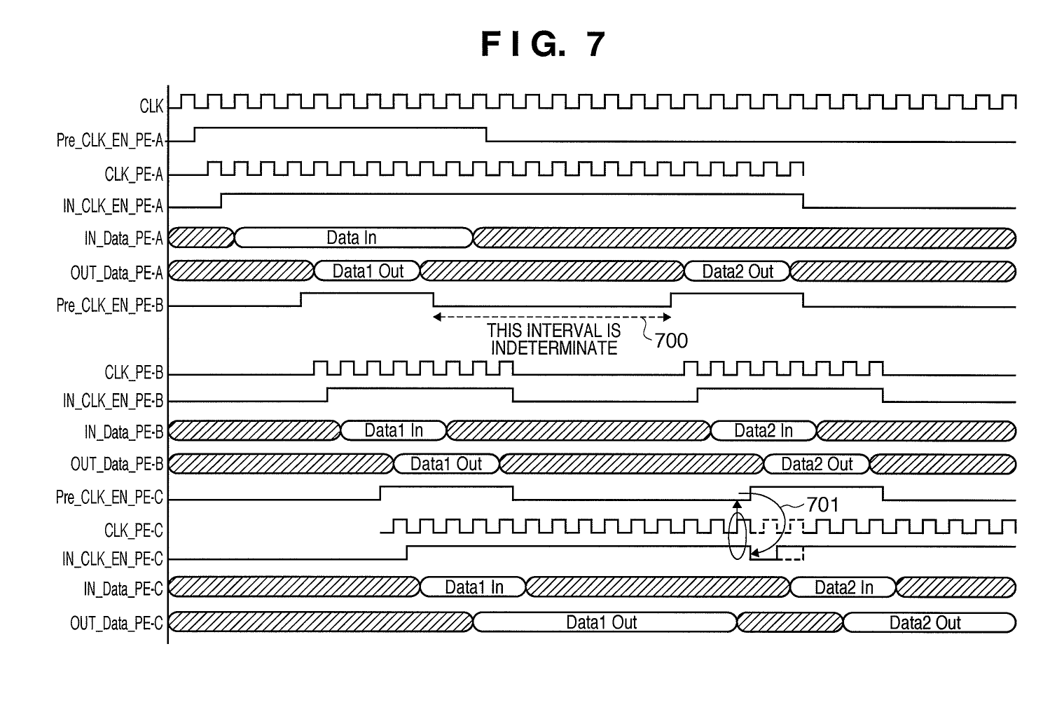

(2) The second characterizing feature will be described in another example of timing using the timing chart of FIG. 7. Since the configuration of the PE, signals and basic control method are the same as in the case described with reference to FIG. 1, these will not be described again.

FIG. 7 is a timing chart illustrating another example of the states of clock signals and data buses of respective PEs shown in FIG. 5 according to this embodiment. For the sake of description, some of the signal names have been changed from those shown in FIG. 5. Each of the signals will now be described.

FIG. 7 illustrates an example in which the particular timing at which data is output to the next PE changes depending upon the content of the input data IN_CLK_EN_PE-A of PE-A 501.

In the example of FIG. 7, the PE-A 501 outputs two items of data (Data1, Data2) with respect to input data. At this time an output time interval 700 between Data1 and Data2 of output data OUT_Data_PE-A becomes indeterminate depending upon the content of data that enters from the preceding stage.

The periods of time (fixed) in which these items of data (Data1, Data2) are processed by the succeeding PE-B 502 and PE-C 503 is as illustrated in FIG. 7. In this case, when the data from the PE-A 501 has been output, care must be taken with regard to processing timing 701 by the PE-C 503. The PE-C 503 completes one unit of processing with respect to Data1 at the timing 701. Since the clock-enable signal Pre_CLK_EN_PE-C from the PE-B 502 at this time is at the low level, the PE-C 503 determines that there is no continuing data and sets internal clock-enable signal IN_CLK_EN_PE-C=0. After one-half of this clock, however, Pre_CLK_EN_PE-C attains the high level again and Data2 is supplied. In order to process Data2, therefore, the design must be such that the clock signal indicated by the broken line will not be lost after the timing 701. In the example of FIG. 7, the clock-enable signal is changed over in synch with the falling edge of the CLK signal, and the other signals are synchronized to the rising edge of the CLK signal. As a result, loss of the clock signal will no longer occur after timing 701.

In the example of FIG. 7, no particular problem arises if the time interval 700 in FIG. 7 is longer than that of the case shown in FIG. 7. Conversely, if the time interval 700 is shorter than shown in FIG. 7, the PE-C 503 cannot process Data2 from the PE-B 502 continuously, and therefore waiting time occurs at the PE-C 503. This also does not represent any particular problem.

FIG. 8 is a diagram illustrating an example of the circuit configuration of a gated-clock unit (clock generator) according to this embodiment.

The clock-enable signal Pre_CLK_EN_PE-* from the preceding stage and the clock-enable signal IN_CLK_EN_PE-* generated within the own PE are input to an OR gate 801. Here the IN_CLK_EN_PE-* signal is an internal signal from the clock control circuit (state machine) described in FIG. 6. Factors involved in generation of the clock-enable signal IN_CLK_EN_PE-* are a reset signal (at the time of initialization) and the signal Pre_CLK_EN_PE-*, but it is assumed that both are synchronized signals. The result of the logical product between the output signal of the OR gate 801 and an external clock signal Ex_CLK(CLK) is output from an AND gate 802. This is the operating clock CLK_PE-*.

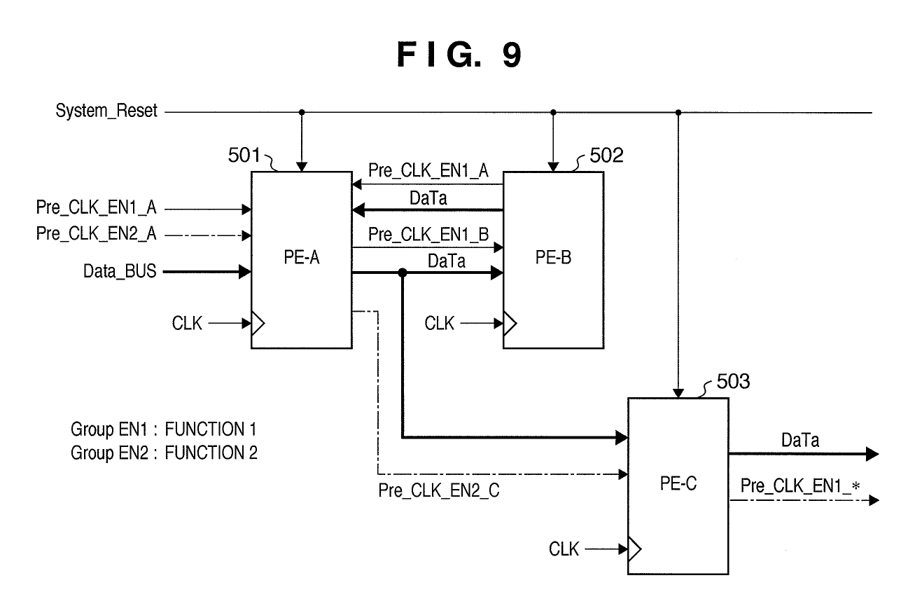

Thus far the basic components of this embodiment have been described using the PE of FIG. 5. Other connection patterns will now be described with reference to FIGS. 9 to 12. The basic structure and signal names, etc., are similar to those shown in FIG. 5 and need not be described again.

FIG. 9 is a diagram illustrating a modification among PEs illustrated in FIG. 5 of this embodiment.

In function 1, data is supplied from the PE-A 501 to the PE-B 502 and the result of processing by the PE-B 502 is returned again as input data to the PE-A 501. In this example of configuration, the clock-enable signal Pre_CLK_EN1_B from the PE-A 501 to the PE-B 502 and the clock-enable signal Pre_CLK_EN1_A from the PE-B 502 to the PE-A 501 are connected. In function 2, data and the clock-enable signal Pre_CLK_EN2_C are being supplied from the PE-A 501 to the PE-C 503.

As in FIG. 5, the PE-A 501 has a circuit relating to Pre_CLK_EN1_A and a circuit relating to Pre_CLK_EN2_A. In a case where these operate independently, it goes without saying that it will suffice to supply the respective clock signals independently only in a case where it is necessary.

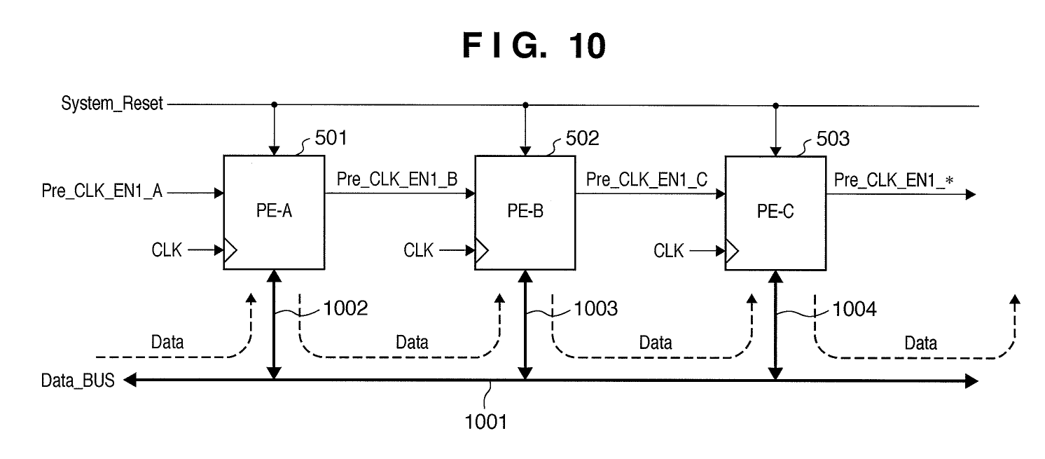

FIG. 10 is a diagram illustrating another modification among PEs illustrated in FIG. 5 of this embodiment.

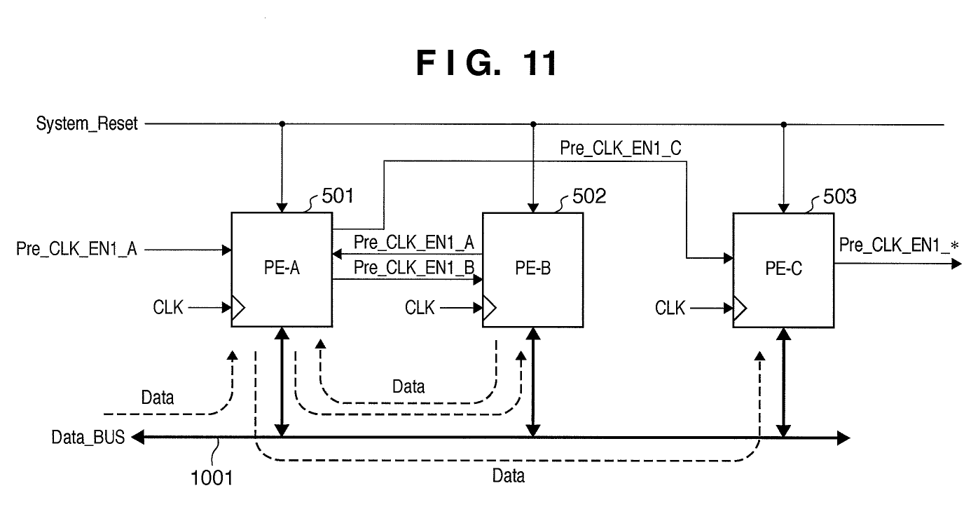

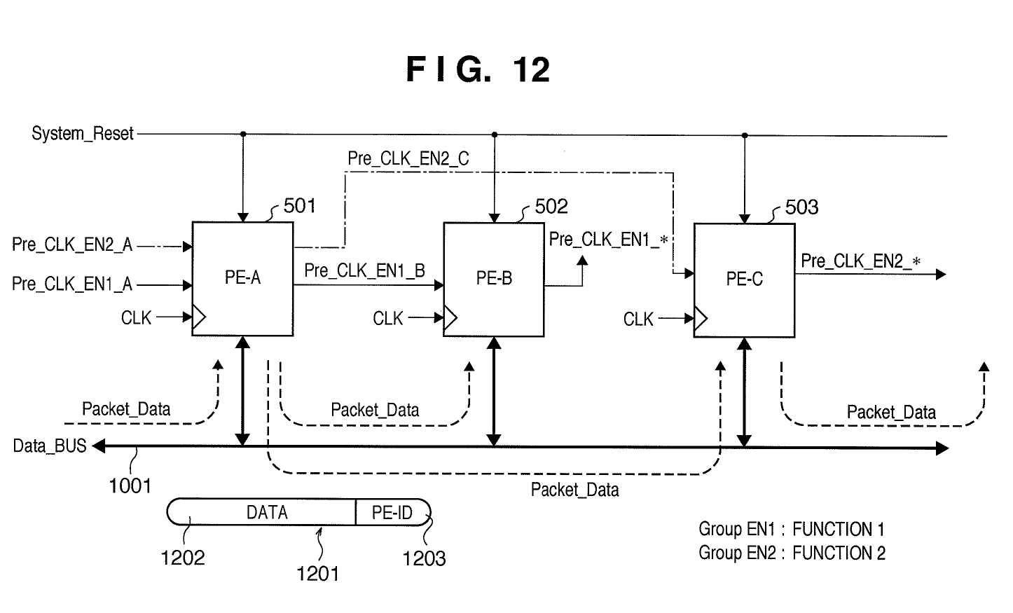

The PE-A 501 to PE-C 503 are connected to a common data bus 1001. Buses 1002 to 1004 connected to respective PEs may each be either a three-state bus or a bus in which a read bus and a write bus are separated independently and connected. However, since the arrangement is complicated, the buses are shown as being gathered into a single bus (the same hold true in FIGS. 11 and 12, described later). In this embodiment, the clock-enable signal can be considered to be a selection signal of each PE. In FIG. 10, therefore, it will suffice if the clock-enable signal Pre_CLK_EN1_(A,B,C) to the PE that desires to transmit data is enabled (made 1) and data is output to the data bus 1001. As a result, the selected PE loads the data on this data bus as input data, as indicated by the dashed-line arrow in FIG. 10.

FIG. 11 is a diagram illustrating an arrangement composed basically of PEs similar to those of FIG. 9, in which data that has been input from the PE-A 501 to the PE-B 502 is returned to the PE-A 501 after being processed by PE-B 502.

As for the connection of the data buses to the PE-A 501 to PE-C 503, the PEs are connected in common with the data bus 1001 in a manner similar to that shown in FIG. 10. The data that the PE-A 501 has accepted from the PE-B 502 is processed by the PE-A 501 and is delivered to the PE-C 503 of the next stage as input data. The flow of data is indicated by the dashed-line arrow in FIG. 11. Before each item of data is output, the clock-enable signal Pre_CLK_EN1_** connected between PEs is enabled (mode 1). This is the same as in the case described above.

FIG. 12 is a diagram illustrating a PE array similar to that of FIG. 10. Here the format of the data that flows in the data bus 1001 is packet data 1201. This differs from the configuration of the drawings described above.

The packet data 1201 is composed of a data portion 1202 and a PE-ID 1203. Each PE that has received the packet data 1201 inputs this packet data only in a case where the PE-ID 1203 of this packet data 1201 matches the PE's own ID. The flow of data is indicated by the dashed-line arrow in FIG. 12. Naturally, in this case as well, before the packet data is output, the clock-enable signal Pre_CLK_EN1_** or Pre_CLK_EN2_** connected between PEs is enabled (made 1).

In the description thus far, an example in which this embodiment is applied is illustrated with regard to the interior of a chip (ASIC). An example of a case where this embodiment is applied between chips on a controller board will now be described.

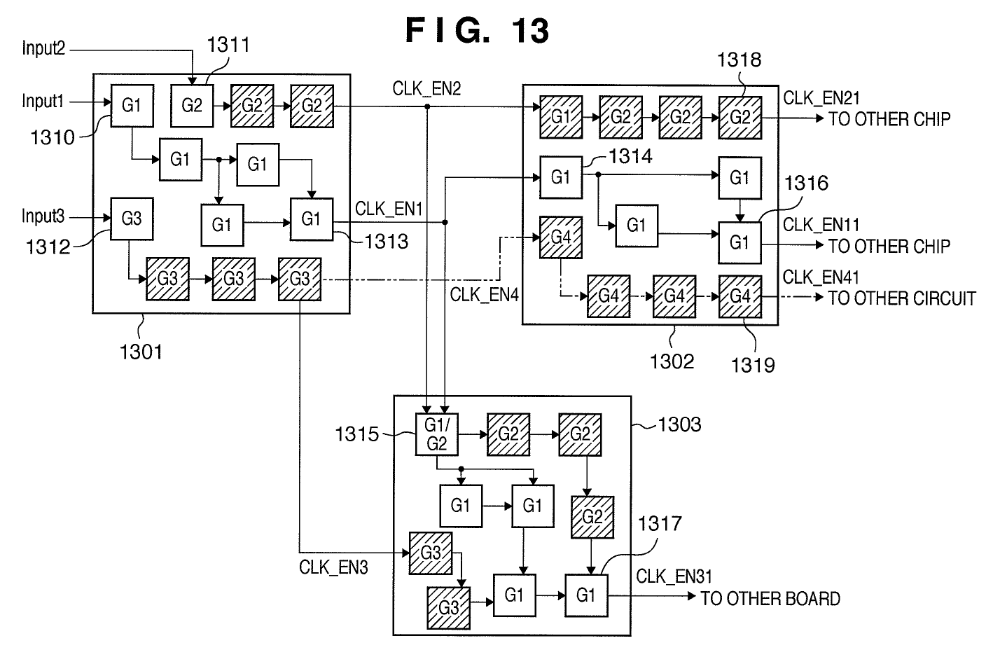

FIG. 13 is a diagram illustrating an example of a configuration in which two sub-chips are connected to a main chip in this embodiment.

Here it is assumed that an externally applied control signal, which serves as a starting point, and input data are all accepted by a main chip 1301, data that has been processed by the main chip 1301 is delivered further to sub-chips 1302 and 1303 and print data is manipulated. Chips that follow the sub-chips 1302, 1303 are not shown and indicated as other chip. Externally applied signals serving as a starting point are supplied from another circuit on the same controller board, or the external port 215, scanner 211 and fax unit 213, etc., of FIG. 3. An externally applied control signal, which serves as a starting point, and input data shall be referred to as a “starting-point signal” below. In FIG. 13, starting-point signals are represented by Input1 to Input3.

PEs in each chip are further divided into processing blocks (PEs) in terms of units of processing. It will suffice if the size of a processing block (PE) thus obtained by division is suitable in accordance with the processing function. Further, the PE illustrated indicates a top PE of processing blocks of the PE. Of course, this embodiment may be applied by dividing the interior of each PE into processing blocks hierarchically. Further, the symbols G1, G2, G3, G4 shown in the interior of each PE indicate groups classified by function. In the example of FIG. 13, therefore, it will be understood that there are four functions corresponding to the G1, G2, G3 and G4. Further, the reset signal and clock signal to each PE, the control signals between PEs and the data buses, etc., are not related to the essence of the description and therefore are omitted. The signal lines connecting PEs elucidate only the clock-enable signals. In particular, the clock-enable signals connecting the chips have their signal names indicated (CLK_EN1 to CLK_EN4: the numerals correspond to the respective functions).

The PEs of the main chip 1301 that receive the starting-point signals (Input1 to Input3) from the outside are indicated at PE 1310 to 1312. Within the PEs indicated by the shading, generation of the clock signal is halted. Further, the PEs indicated in white represent PEs in which processing is in progress.

In the example of FIG. 13, the starting-point signal Input1 is input to G1 (1310), whereby processing of function 1 (G1) of main chip 1301 is started. All of the elements G1 of main chip 1301 are indicated in white. As mentioned above, generation of the clock signal reaches the final G1 (1313) while on/off is repeated accompanying the data.

Ahead of the final G1 (1313), the clock-enable signal CLK_EN1 emerges from the main chip 1301 and enters G1 (1314) of sub-chip 1302 and G1/G2 (1315) of sub-chip 1303 (G1/G2 signifies a processing block PE common to both functions 1 and 2, as described in FIG. 5). As a result, the data that has been output from the final G1 (1313) is delivered to G1 (1314) and to G1/G2 (1315). Here, by way of example, a case is considered in which G1 (1313) outputs data continuously, the odd-numbered data of this data is accepted by G1 (1314), and the even-numbered data is accepted by G1/G2 (1315).

Within the sub-chip 1302 and sub-chip 1303 that have thus accepted the data, the clock-enable signals are propagated and data is processed in a manner similar to that of the main chip 1301. When the data arrives at the final G1 (1316) and final G1 (1317) within the respective sub-chips, the respective clock-enable signals are output to the exterior of the sub-chips and are transmitted to other chips, etc.

As already mentioned, a characterizing feature of this embodiment is that even a PE in which processing is in progress and is active as represented by being white will halt generation of the clock signal in a time interval in which there is no data to be processed (i.e., after the data has passed through).

Furthermore, the clock-enable signals connected from the final G1 (1316) and final G2 (1318) of the sub-chip 1302 to the exterior of the sub-chips are connected to other chips, as indicated at sub-chip 1302 and sub-chip 1303. Further, the clock-enable signal connected from the final G4 (1319) of the sub-chip 1302 to the exterior of the sub-chip is connected to another chip on the controller board. Furthermore, the clock-enable signal connected from the final G1 (1317) of the sub-chip 1303 to the exterior of the sub-chip is connected to another board. Although not illustrated, the scope of application of this embodiment is not limited to the interior of a chip or between chips described thus far; the embodiment is also applicable, according to the same principles, to other circuits on the board, an external board and an external device. Further, although this embodiment has been described taking the control system of a printer as an example, it goes without saying that the invention is applicable in general to any digital circuit.

It should be noted that although a chain of clock-enable signals is connected to the sub-chips 1302 and 1303 starting from the main chip 1301 function by function (G1, G2, G3, G4), a location at which a group number changes within a sub-chip along the way means that processing is shared.

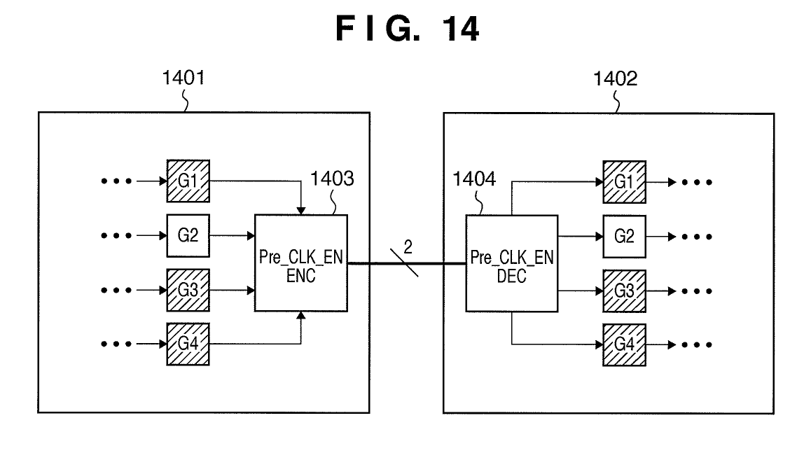

FIG. 14 is a diagram useful in describing another example in which a clock-enable signal between chips is connected according to this embodiment.

As illustrated in FIG. 14, clock-enable signals from final PEs (G1, G2, G3, G4) of a main chip 1401 are transmitted upon being encoded by an encoder (Pre_CLK_EN ENC) 1403. On the other hand, a sub-chip 1402 on the receiving side receives the clock-enable signal and decodes the signal using a decoder (Pre_CLK_EN DEC) 1404, thereby distributing clock-enable signals to leading PEs (G1, G2, G3, G4) within the sub-chip 1402. In FIG. 14, only the PE corresponding to function 2 executes processing, and operation of the PEs implementing the other functions is halted.

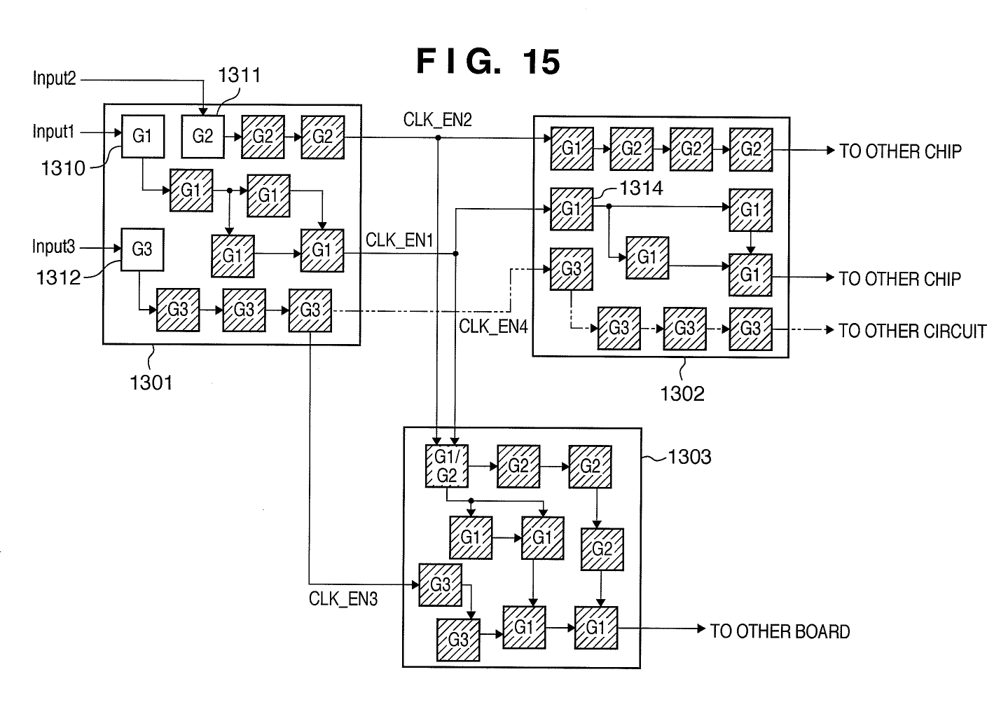

FIG. 15 illustrates a configuration identical with that of FIG. 13 and represents conditions at the time of standby. Components in FIG. 15 identical with those shown in FIG. 13 are designated by like reference characters.

Only G1 (1310), G2 (1311) and G3 (1312) of the main chip 1301 that receives the starting-point signals Input1 to Input3 are in a state in which the clock signals are being generated at all times. It will be understood that the other PEs (both main and sub-chips) are in a state in which generation of the clock signals is halted (these PEs are indicated by the shading). That is, in the standby state, power consumption can be held to the minimum by the starting-point signals even though the state is the operable state.

In this embodiment, as will be understood from the description thus far, the basic structure is such that each PE, which is a unit of processing, concentrates on its own processing and does not detect handshake with another party. Consequently, the PEs need only be connected in a daisy chain by the clock-enable signals, and the structure can be made very simple. Accordingly, the scope of application of this embodiment is not limited to the interior of a chip or between chips; the embodiment is also applicable between other chips, on-board circuits, external boards and external devices.

A clock signal is generated in a time interval in which data to be processed exists, not only in the standby state but even when execution of processing is in progress, as at the time of printing. In other time intervals, a state in which the clock signal is not supplied can be established. As a result, it is possible to suppress power consumption, inclusive of standby power and operating power of a printer.

It goes without saying that, in general, turning off the electric power supply is better at suppressing power consumption than halting the clock signal. In such case, however, initialization processing becomes necessary whenever the electric power supply is turned on, and there is a tradeoff between processing time and processing performance. Further, turning supply of power on and off is technically difficult in PE units of small circuits within an ASIC. That is, the method of this embodiment is a method having good balance between total suppression of power consumption and processing performance.

Further, although a method of executing processing for halting supply of a clock signal by software means is generally carried out, the length of time over which the clock signal can be turned on and off is approximately several milliseconds to tens of milliseconds in such case.

By contrast, with this embodiment, processing can be executed by using a simply constructed clock control circuit and daisy-chain-connecting PEs corresponding to the processing units that include this circuit by clock-enable signals. As a result, processing is possible with a length of time for controlling the clock signal that is on the order of the period of the clock signal [ns (10⁻⁹ s) or ps (10⁻¹² s)], and it is possible to maximize the efficiency of power reduction.

Thus, in accordance with this embodiment, the circuit configuration is simple and processing blocks (PEs) are merely connected into a daisy chain by clock-enable signals. This makes possible application not only to the interior of a chip but also over a wide range such as between other chips, on-board circuits, external boards and external devices. It is possible to suppress the power consumption of the overall system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-246094, filed Sep. 21, 2007, which is hereby incorporated by reference herein in its entirety.

What is claimed is:

1. An electronic device having a plurality of processing elements PEs that operate in synch with a clock signal, each of the plurality of PEs comprising:
a clock generator configured to generate an operating clock signal of the PE in accordance with a clock enable signal that is input together with data from an outside or from a PE of a preceding stage;
a processing unit configured to process input data in a case where the clock generator generates the operating clock signal;
an output unit configured to output a clock enable signal to a PE of a succeeding stage and output processed data, which has been processed by the processing unit, to the PE of the succeeding stage; and
a halt unit configured to halt generation of the operating clock signal by the clock generator in response to completion of processing of the input data by the processing unit and completion of output of the processed data by the output unit.

2. The device according to claim 1, wherein the halt unit halts generation of the operating clock signal by the clock generator in a case where the clock enable signal that is input from the PE of the preceding stage is not enabled at the time of completion of output of the processed data by the output unit after processing of the input data has been completed by the processing unit.

3. The device according to claim 1, wherein in a case where the PE is capable of executing a plurality of functions, the clock enable signal is input to the PE from the PE of the preceding stage function by function.

4. The device according to claim 1, wherein the output unit outputs the processed data processed by the processing unit after the output unit outputs the clock enable signal to the PE of the succeeding stage.

5. The device according to claim 1, wherein each of the plurality of PEs transits to a state in which the amount of power consumption has been reduced, in a case that the clock enable signal is not supplied to the PE.

6. The device according to claim 1, wherein the clock enable signal that is input from the PE of the preceding stage is a signal having a prescribed duration.

7. The device according to claim 1, wherein the clock enable signal that is output to the PE of the succeeding stage is a signal having a prescribed duration.

8. A method of controlling power of an electronic device having a plurality of processing elements PEs that operate in synch with a clock signal, the method comprising:
a clock generating step of generating at each of the plurality of PEs an operating clock signal of the PE in accordance with a clock enable signal that is input together with data from the outside or from a PE of a preceding stage;
a processing step of processing input data at each of the plurality of PEs in a case where the operating clock signal is generated in the clock generating step;
an output step of outputting a clock enable signal to a PE of a succeeding stage and outputting processed data, which has been processed in the processing step, to the PE of the succeeding stage; and
a halting step of halting generation of the operating clock signal in the clock generating step in response to completion of processing of the input data in the processing step and completion of output of the processed data in the output step.

9. The method according to claim 8, wherein the halting step halts generation of the operating clock signal in a case where the clock enable signal that is input from the PE of the preceding stage is not enabled at the time of completion of output of the processed data in the output step after processing of the input data has been completed in the processing step.

10. The method according to claim 8, wherein in a case where the PE is capable of executing a plurality of functions, the clock enable signal is input to the PE from the PE of the preceding stage function by function.

11. The method according to claim 8, wherein the output step outputs the processed data processed in the processing step after the output step outputs the clock enable signal to the PE of the succeeding stage.

12. The method according to claim 8, wherein each of the plurality of PEs transits to a state in which the amount of power consumption has been reduced, in a case that the clock enable signal is not supplied thereto.

13. The method according to claim 8, wherein the clock enable signal that is input from the PE of the preceding stage is a signal having a prescribed duration.

14. The method according to claim 8, wherein the clock enable signal that is output to the PE of the succeeding stage is a signal having a prescribed duration.
